(19) United States
(12) Patent Application Publication
(10) Pub. No.: US 2026/0320239 A1
(43) Pub. Date: Oct. 15, 2026

(54) MACHINE AND PROCESS TO CREATE A FOIL

(71) Applicant: The Boeing Company, Arlington, VA (US)

(72) Inventors: Sina Rafati, Santa Ana, CA (US); Amir Afrasiabi, Laguna Niguel, CA (US)

(21) Appl. No.: 19/179,559

(22) Filed: Apr. 15, 2025

(51) Int. Cl. G06F 30/17; G06F 30/27

(52) U.S. Cl. CPC G06F 30/17; G06F 30/27

(57) ABSTRACT

A machine and process for process for creating a foil that includes: applying, in an auto-encoder, one or more transformations to digital parameters of existing foils and generating a latent-space representation of the digital parameters; training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation; and further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network.

### BACKGROUND INFORMATION

### 1. Field

The present disclosure relates generally to a machine and process to create a foil. More specifically, the present disclosure relates to a machine and process to create a foil that produces forces in a fluid flow.

### 2. Background

Design engineers create initial designs for a foil either through a Direct Method or an Inverse Design (known shapes and optimized goal or known parameters and no known shape). Constraints may exist on foil geometry or performance requirements. Pressure distributions, lift, and drag for a foil may be estimated in an analytic design program. Current analytic design programs may only have limited processing speed and/or volume capabilities. Current analytic design programs may only be accurate within a limited linear angle of attack range and below a Mach number of 0.4. Current analytic design programs may overpredict lift and underpredict drag. Current analytic design programs may not be able to accurately model stall and post-stall conditions and/or performance for the foil.

Design engineers may utilize current Computational Fluid Dynamics (CFD) techniques to derive an enhanced estimate for the pressure distribution, lift, drag, and other performance characteristics for the foil. Enhanced estimates may be needed to facilitate optimizing a foil shape to achieve specified characteristics. The process of airfoil design may also be enhanced by an individual designer's judgements based upon individual knowledge including flow boundary layer properties and relations between foil geometry and pressure distribution.

Current design of a foil may also include building a prototype for physical testing (e.g., Wind Tunnel) to validate CFD estimations. Currently, the full process requires a large investment of manpower, time, material and/or computer resources, and cost.

Therefore, it would be desirable to have a method and apparatus that take into account at least some of the issues discussed above, as well as other possible issues. For illustration, it would be desirable to have a method and apparatus that overcome a technical problem with improving performance characteristics and reducing design and/or manufacturing time and/or cost.

### SUMMARY

Embodiments of the present disclosure provide a process for creating a foil. The process may include: receiving, from a number of databases, digital parameters for existing foils and existing foil designs and performance values therefrom; applying, in an auto-encoder, one or more transformations to the digital parameters and generating a latent-space representation of the digital parameters for all of the existing foils and the existing foil designs; receiving from the number of databases or deriving, using deep learning and an airflow simulator, performance values for each foil in the existing foils and the existing foil designs in a number of airflow parameters and transforming the latent-space representation by incorporating the performance values and expanding the latent-space representation; training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation; and further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network. The process may also include formats among the number of databases being dissimilar.

Deriving the performance values in the process for creating a foil may also include: initializing a model of an existing foil or an existing foil design in a digital computer with parameters comprising dimensions and materials; generating a set of airflow parameters comprising a Mach number and a Reynolds number, and simulating the airflow parameters flowing over the model; and applying algorithms simulating the set of airflow parameters over the model and generating the performance values for the model. The digital parameters may include at least one of: geometric coordinates for a shape of an existing foil or an existing foil design, and a material of the existing foil or the existing foil design. The geometric coordinates may be two dimensional coordinates.

In the process for creating a foil, the performance values may include values for at least: coefficient of pressure, lift coefficient, drag coefficient, and pitching moment coefficient. The airflow parameters may include at least one of: Reynolds number, angle of attack, Mach number, density, viscosity, or compressibility.

The process for creating a foil may also include replacing the regression neural network with a generative adversarial network. The process for creating a foil may also include replacing the regression neural network with a latent diffusion model transforming the latent-space representation with a denoised latent-space representation. The process for creating a foil may also include receiving, in a neural network comprising a trained latent-space representation: objectives, constraints, or desired foil parameters, and generating parameters of an optimal foil. The optimal foil may include at least: geo-coordinates, dimensions, and materials defining the optimal foil. The optimal foil may include all of the desired foil parameters.

The process for creating a foil may also include receiving, in design algorithm that includes a trained latent-space representation: objectives, constraints, foil parameters, or desired performance values, and producing a list of optimized foils. The objectives may include desired performance values. Training a foundation model wrapper, for inputting objectives, constraints, or foil parameters, into a design algorithm may include using a trained latent representation. The process may involve a design algorithm for generating performance values using the latent-space representation without utilizing: an airflow simulator, computational fluid dynamics, or a wind tunnel.

Embodiments herein include a machine configured to manufacture a foil. The machine may include: a processor configured to receive inputs that include: existing foil parameters, airflow parameters, and performance values for the airflow parameters acting on the existing foil parameters, in differing formats; and transform the inputs of: the existing foil parameters, the airflow parameters, and the performance values trained in a neural network that pairs them into a unified format in a latent-space representation.

The machine may also include a neural network configured to iteratively train a design generator to transform and expand the latent-space representation with new foil parameters and performance values associated with the new foil parameters; and a foundation model configured to receive an input that may include: objectives, constraints, foil parameters, or desired performance values, and transform them into digital inputs to a design algorithm configured to, based upon a trained design generator and the latent-space representation, generate parameters that define an optimal foil.

Input to the foundation model may include a spoken or a natural text. The machine may also include a computer aided design module configured to receive and transform generated parameters into commands to fabricate the optimal foil.

Embodiments herein may also include a process for manufacturing a foil. The process may include: receiving, from a number of databases, digital parameters for existing foils and existing foil designs and performance values therefrom; applying, in an auto-encoder, one or more transformations to the digital parameters and generating a latent-space representation of the digital parameters for all of the existing foils and the existing foil designs; receiving from the number of databases or deriving, using deep learning and an airflow simulator, performance values for each foil in the existing foils and the existing foil designs in a number of airflow parameters and transforming the latent-space representation by incorporating the performance values and expanding the latent-space representation; training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation; further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network; receiving in a foundation model an input comprising a spoken or a natural text that may include: objectives, constraints, foil parameters, or desired performance values, and transforming them into digital inputs to a design algorithm configured to, based upon a trained design generator and the latent-space representation, generating parameters defining an optimal foil; a computer aided design module receiving generated parameters and transforming them into commands for fabricating the optimal foil; and manufacturing, using the commands, the optimal foil.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1A is a block diagram of current tools for derivation of performance values for a foil in accordance with an illustrative embodiment;

FIG. 1B is a block diagram of current tools for derivation of performance values for a foil in accordance with an illustrative embodiment;

FIG. 2 is a block diagram for a machine that trains a neural network to create a new foil in accordance with an illustrative embodiment;

FIG. 3 is a flowchart for a process for creating a foil in accordance with an illustrative embodiment;

FIG. 4 is a flowchart for a process for manufacturing a foil in accordance with an illustrative embodiment;

FIG. 5 is an illustration of a block diagram of a data processing system in accordance with an illustrative embodiment;

FIG. 6 is an illustration of an aircraft manufacturing and service method in accordance with an illustrative embodiment;

FIG. 7 is an illustration of a block diagram of an aircraft in which an illustrative embodiment may be implemented; and

FIG. 8 is an illustration of a block diagram of a product management systemin accordance with an illustrative embodiment.

### DETAILED DESCRIPTION

The illustrative embodiments recognize and take into account one or more different considerations as described herein. Without limitation, the illustrative embodiments recognize and take into account that design and manufacture of foils account for complex factors such as aerodynamics, material strength, and weight.

A longstanding goal exists to design and manufacture foils that meet more efficient specified performance parameters within specified geometric limits that are produceable with less and/or lighter materials with specified structural characteristics within a desired timeframe and cost. Foil performance may have practical applications in a number of fluids to include,, without limitation, air and water. Hence, foil performance may be necessary, without limitation, for aquatic as well as aerospace vehicles, as well as terrestrial vehicles with foil technologies. Thus, as used herein the term foil may indicate an airfoil, or be applicable to foils in other fluid mediums. Therefore, one of ordinary skill in the art recognizes that embodiments herein described for airfoils and airflows may be applicable to foils in other fluid mediums.

Without limitation, the illustrative embodiments recognize and take into account that increasing a lift-to-drag ratio in airplane aerodynamics is essential to improve fuel efficiency, extend range, and for better overall flight performance. Higher L/D ratios enable greater altitude, endurance, and speed potential, aligning with industry goals of sustainability and cost-effectiveness. Generative design tools can enhance design efficiency, as well as reduce manual effort and time and dependence upon individual experience and expertise. Generative design may begin by setting design objectives, constraints, and parameters to include, without limitation, material properties. Generative design programs may apply machine learning from existing wing designs and aerodynamic principles. Generative design tools may apply algorithms that iteratively produce, assess, and refine airfoil shapes based on desired outcomes. Simulations may be applied to analyze the performance of each design and feed the results back into an optimization model.

Besides, going through process of airfoil optimization require series of iterations from design optimization and then simulation of performance through packages such as an open source program like XFOIL. Our focus is to design a deep learning model that can accelerate the simulation for estimation drag/lift and also an optimization model to continuously improve the airfoil design. A foundation model wrapper may be trained such that all constraints may be provided as natural language input and converted to appropriate constraints for optimization process.

Without limitation, the illustrative embodiments recognize and take into account that predominant among performance parameters for design and/or evaluation of a foil are lift and drag, and/or a ratio therebetween, and/or a maximization of the lift/drag ratio. Without limitation, for vehicles operating in liquid, wave-drag and/or a minimization thereof may be a predominant performance parameter for evaluation and/or design considerations.

Without limitation, the illustrative embodiments recognize and take into account that,, without limitation,: foil structure, performance, and efficiency can affect characteristics and performance for a vehicle utilizing the foil that may include, without limitation,: a shape, a size, a weight, a speed, a fuel economy, operating envelope, endurance, and/or range, of the vehicle. Improved characteristics and performance for the vehicle may improve the sustainability and/or cost effectiveness of, without limitation, a production and/or operation of the vehicle.

Without limitation, the illustrative embodiments recognize and take into account that current foil Direct Method designs may begin with accessing a series of known foil shapes with recorded performance values, such as, without limitation, the National Advisory Committee for Aeronautics (NACA) series of foil shapes. Performance values may include pressure distribution, lift, and drag, represented, without limitation, by a coefficient of pressure, a lift coefficient, a drag coefficient, and a pitching moment coefficient.

When a known foil shape does not produce desired performance characteristics, a designer may modify the shape to attempt to produce desired performance. Such a direct method suffers the technological problems that include at least: identifying measures of performance for all of the performance results affected by a change to a shape of a foil, choosing a technique to change a shape to achieve improved performance for one or a collection of performance parameters to avoid driving other parameters out of acceptable ranges, and manufacturing/maintenance considerations/capabilities for modified shapes. Such a process and current tools available require significant designer experience and expertise to identify any undesired effects of a change in foil shape and alter foil shape to overcome the undesired effects. Such a process and current tools available may require significant use of time and energy applying CFD and/or model (wind tunnel) testing to identify all significant effects of a change in foil shape. While a current Direct Method of designing a foil does not require a specific definition of a scalar objective function, it does require a designer/design group with advanced levels of experience and expertise to identify potential problems of performance across multiple parameters and manufacture (which may require an additional dedicated designer/design group) considerations for a designed foil and often considerable expertise to overcome performance problems.

Without limitation, the illustrative embodiments recognize and take into account that current foil Indirect Method designs (aka. Inverse Design) may specify a desired objective function/performance characteristic, such as, without limitation, a particular distribution of Coefficient of Pressure (Cp) across the foil. Foil shape Inverse Design may begin with the desired objective and designer experience and expertise with effects of various geometric shapes and changes applied to craft a foil geometry intended to produce the desired function/performance characteristics. Such a process and current tools available may require significant use of time and energy applying CFD and/or model (wind tunnel) testing to identify all significant effects of a change in foil shape.

Inverse Design may also involve numerical optimization, using shape functions to represent a geometry of a foil and then attempting sequences of modifications that attempt to improve performance characteristics for the design. Without limitation, a subsonic airfoil development system may be applied as an interactive program to design and analyze certain subsonic airfoils. As a nonlimiting illustration, a subsonic airfoil development system may be applied, if given coordinates specifying a shape of a 2D airfoil, Reynolds and Mach numbers, to calculate a pressure distribution on the airfoil and hence lift and drag characteristics for a geometric shape of the foil.

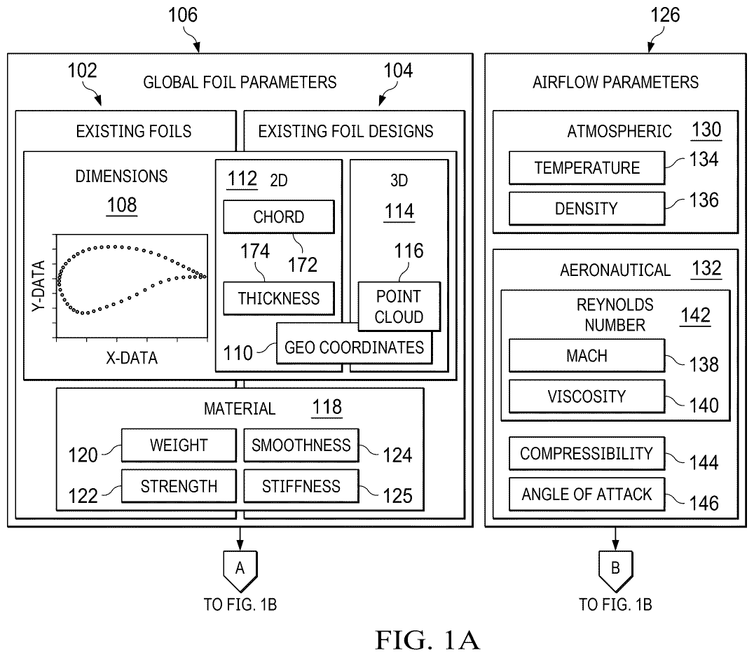

With reference now to the figures and, in particular, with reference to FIG. 1A and FIG. 1B, FIG. 1A and FIG. 1B are together a block diagram of current tools for derivation of performance values 128 for a foil in accordance with an illustrative embodiment. Specifically, FIG. 1A shows that currently there exist a number of existing foils 102 and/or a number of existing foil designs 104 that have parameters that are recorded around the world as a number of foil parameters stored in a number of data storage locations, formats, and/or languages, collectively represented in FIG. 1A as global foil parameters 106. Respectively, for every foil in existing foils 102 and/or for every design in existing foil designs 104, there may be parameters that define dimensions 108 for each foil. Dimensions 108 may include, without limitation, geocoordinates 110 that may be two dimensional (2D) 112 or three dimensional (3D) 114. Geocoordinates 110 for a foil may indicate dimensions 108 for, without limitation, a camber, chord 172, and/or a thickness 174 of the foil. Without limitation, 3D 114 data may be stored as point cloud 116 for each foil in global foil parameters 106. Current global foil parameters 106 may include stored values for a number of series of existing foils 102 and/or existing foil designs 104 such as, without limitation, the U.S. (NACA) National Advisory Committee for Aeronautics series of airfoils or the Royal Aircraft Factory family of airfoils.

Global foil parameters 106 may also include,, without limitation, stored data that may define material 118 used in each foil therein. Data describing material 118 may include any characteristic of each foil that may include,, without limitation, weight 120, strength 122, smoothness 124, and/or stiffness 125 of material 118. Without limitation, data for material 118 may be sectioned for different portions of any given foil in existing foils 102 and/or existing foil designs 104. In other words, different portions of an individual foil may have a number of sections that each may have parameters of material 118, weight 120, strength 122, and/or smoothness 124 that are unique from other sections of the foil. Global foil parameters 106 may be stored, without limitation, in a number of locations, in a number of languages, a number of publications, and/or in a number of different codes and/or data formats.

Airflow parameters 126 may be applied to any foil defined by global foil parameters 106 to produce performance values 128 for a foil selected in global foil parameters 106. Without limitation, airflow parameters 126 may include atmospheric 130 and/or aeronautical 132 data defining parameters for air that may flow over a selected foil. At least for airflow parameters 126, atmospheric 130 data may include, without limitation, temperature 134 and/or density 136 of the air that is flowing across one of the existing foils 102 and/or existing foil designs 104. Without limitation, aeronautical 132 data may include parameters for Mach 138, viscosity 140, Reynolds number 142, compressibility 144, and/or (AOA) angle of attack 146. Airflow parameters 126 may be stored in a number of locations, in a number of languages, and/or in a number of different codes and/or data formats.

One of ordinary skill in the art understands that although FIG. 1A illustrates the flow over existing foils 102 and/or existing foil designs 104 as being air, that the flow could be water, and thus appropriate marine data may replace the illustrations shown for atmospheric 130 and/or aeronautical 132. Similarly, other analogous to airfoil parameters may apply to other fluids, such as, without limitation, hydraulic and/or cooling fluids. Accordingly, appropriate data may replace the illustrations shown for atmospheric 130 and/or aeronautical 132 as apply to another fluid environment.

Changing any of the airflow parameters 126 and/or combinations thereof may alter performance values 128 produced by any given foil. Hence, for any particular existing foil and/or existing foil design in one of a number of storage locations for some number of global foil parameters 106, performance values 128 may also be associated and stored for the particular foil for each of a number of combinations of different airflow parameters 126. Alternatively, some number of storage locations for some number of global foil parameters 106, may have performance values 128 for some limited number of airflow parameters 126 applied to each airfoil therein.

Currently, performance values 128 may be derived by performance evaluators 148 such as analytics programs, without limitation, such as open source program XFOIL 150, computational flow dynamics 152 (CFD) programs, wind tunnel 154 evaluations, and/or test flights 156. XFOIL 150 will calculate performance values 128 for pressure distribution 158, lift 162, and/or drag 164 for an airfoil represented by a set of global foil parameters 106 for a given Mach 138 and Reynolds number 142. XFOIL 150 and Computational flow dynamics 152 may be considered forms of airflow simulation over a foil shape.

Without limitation, performance values 128 may include values for pressure distribution 158 around a foil, coefficient of pressure (Cp) 160 for points along a foil, as well as lift 162, drag 164, pitching moment 166, and associated coefficient of lift (Cl) 166, coefficient of drag (Cd) 168, and pitching moment coefficient (Cm) 170 for points along the foil. Also shown in FIG. 1B are a couple of nonlimiting examples of how performance values 128 may be presented in various formats such as without limitation, a graph 176 as shown in FIG. 1B for Coefficient of Pressure/Cp 160 along a 2D 112 chord line presented with Cp values along a Y axis and percent of length of the chord from a front of a foil (with a specified C_{L} 166, C_{M} 170 and angle of attack) along an X axis. Performance values 128 may also be presented in various formats such as without limitation, a graph 178 as shown in FIG. 1B of a ratio of lift 162 to drag 164 along a Y axis and an angle of attack (or alpha) value along an X axis. Without limitation, numerous forms of presentation may be presented for performance values 128 to include, without limitation, charts, tables, lists, and/or other pictorials.

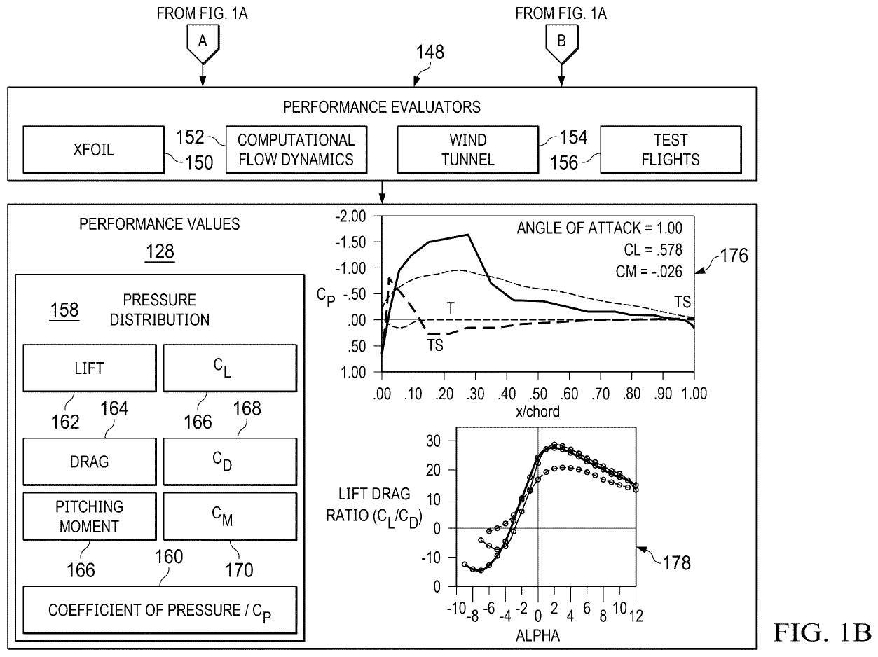

Turning now to FIG. 2, FIG. 2 is a block diagram for a machine that trains a neural network 214 to create a new foil in accordance with an illustrative embodiment. More specifically, machine 200 may include data extractor 202 that may be a processor that may include, without limitation, natural language processor 204 that may include, without limitation, tokenizer 208, and/or translator 210, in communication with encoder-decoder 206. Just as a particular tool may be given a formal name, such as an Allen wrench, the novel machine 200 to generate optimal foil 211 may also be referred to by its formal name, Sinamir. Without limitation, Sinamir 200 may be a processor or may include a network of processors. Data extractor 202 may be configured to search out, gather, translate and/or transform/reformat all accessible existing global foil parameters 106, associated airflow parameters 126, and resultant performance values 128 for processing by trainer 212 of neural network 214.

Encoder-decoder 206 may be encoder-decoder 206 that is automatic. Encoder-decoder 206 may apply deep-learning processing. Encoder-decoder 206 may compress and reformat global foil parameters 106, associated airflow parameters 126, and resultant performance values 128, into latent-space representation 216.

Trainer 212 uses all global foil parameters 106, associated airflow parameters 126, and resultant performance values 128 reformatted into latent-space representation 216 and trains neural network 214 with them through regression 218, generative adversarial 220 network, and/or diffusion 222. Once latent-space representation 216 has been reformatted through neural network 214 training, neural network 214 can function as a feed-forward loop to reiteratively generate geocoordinates 110 for a new foil shape that was not a part of global foil parameters 106, apply a selection of airflow parameters 126 to the new foil shape, and derive through neural network 214 estimation of new performance values 128 for the new foil shape, and therewith, reformatting and expanding the latent-space representation 216 to include the new foil shape, applied airflow parameters 126, and performance values 128 therefor.

Significantly, neural network 214, when trained, can predict performance values 128 for a new foil without utilizing any: program analytics, Computational Fluid Dynamics calculations, wind tunnel, and/or test flights. Thus, Sinamir 200 provides the technological advantage of generating new foil shapes and their associated performance values 128 without requiring the processing and/or other resources, time, and/or manpower required to derive performance values 128 using currently available tools. Neural network 214 may be activated to iteratively operate to reformat and expand latent-space representation 216 until all, or all within some selected set of limits, possible new foil shapes and resultant performance values 128 are incorporated into expanded and reformatted latent-space representation 216.

Similarly, for any foil described in global foil parameters 106 that has not had a particular combination of airflow parameters 126 applied to generate performance values 128 therefor, neural network 214 can iteratively apply any desired range and/or set of combinations of airflow parameters 126 to estimate performance values 128 from that foil which can be validated through diffusion 222 and/or generative adversarial 220 network in neural network 214 and if validated, used to transform and/or expand latent-space representation 216. Thus, once initial trained, neural network 214 can continuously function to expand and/or reformat latent-space representation 216 and thereby continuously refine its precision until latent-space representation 216 contains all possible shapes and performance values 128 for all possible airfoil parameters.

Further still, user interface 224 may interact with latent-space representation 216 to formulate indirect design requests through foundation model 226. Foundation model 226 may be a language learning model (LLM) that may be configured to receive text and/or spoken natural language commands that may apply objectives 228 and/or constraints 230 that neural network 214 may pair with selections from airflow parameters 126, performance values 128, and/or global foil parameters 106 for input 232 to estimate an optimal output 234 to satisfy constraints 230 and/or objectives 228 entered into input.

Thus, as a nonlimiting illustration, if input 232 to neural network 214 were a novel foil shape in the form of a set of geocoordinates 110 and a selection of airflow parameters 126, neural network 214 may use latent-space representation 216 to estimate performance values 128 for the novel foil shape. Alternatively, if input 232 to neural network 214 included constraints 230 to elements of dimensions 108 and/or material 118 and objectives 228 for performance values 128, then neural network 214 may use latent-space representation 216 to predict and output geocoordinates 110 that decoder of encoder-decoder 206 could translate to present an image of a foil on user interface 224. As a nonlimiting illustration, constraints 230 may include, without limitation,: a foil thickness of less than 6 inches with a weight 120 of 10 pounds in an airflow less than 0.8 Mach 138, while objectives 228 might include, without limitation,: a lift 162 of at least 1000 pounds-force with a drag 164 of no more than 10 pounds-force then neural network 214 may use latent-space representation 216 to predict geocoordinates 110 for an optimal foil 211 shape 236 to satisfy the constraints 230 and objectives 228. As with global foil parameters 106, optimal foil 211 may also be defined by dimensions 108 and material 118. Without limitation, output 234 for optimal foil 211 may be just a description by geocoordinates 110. Optimal foil 211 shape 236 may be from among existing foils 102 and/or existing foil designs 104 as represented in latent-space representation 216, or may be a novel set of geocoordinates 110 for a new foil shape generated by the neural network 214 utilizing the latent-space representation 216.

Output 234 with of optimal foil 211 shape 236 may include a listing of all performance values 128 for the optimal foil 211 shape 236 for all airflow parameters 126 that include input 232 constraints 230. Output may be processed through decoder of encoder-decoder 206 to display on user interface 224, without limitation, as lists and/or graphs of the geocoordinates 110 and performance values 128 and/or an image of the shape of the new foil 246. Output 234 may be more than a single set of geocoordinates 110. In other words,, without limitation, output 234 of optimal foil 211 shape 236 may include parameters defining a number of foils that meet all constraints 230 and objectives 228. The number of foils may be presented on user interface 224 in a ranked order based upon degree of satisfaction of constraints 230 and objectives 228.

Hence, output 234 from neural network 214 and auto-generator 238 may contain new: performance values 128, airflow parameters 126, and/or performance values 128 that may be sent as input 232 directly back into trainer 212 in auto-generator 238 to update, expand, and/or reformat latent-space representation 216 in a complete automatic and continuous feedback loop. Output 234 from neural network 214 and auto-generator 238 may also be sent for display on user interface 248.

Input 232 may include bias 248, or output 234 may be sorted for display based upon bias 248 for selected constraints 230 and/or objectives 228. As a nonlimiting illustration, if three foils met all constraints 230 and objectives 228 and they produced lift 162 of 1200, 1400, and 1500 pounds-force and maximum lift 162 were biased as the most significant of objectives 228, then the foil 246 producing the 1500 pounds-force would be presented at the top of a list for optimal foil 211 shape 236.

In other words, machine 200 may be considered a machine configured to generate an optimal foil 211 to be manufactured and/or formed in flight. Accordingly, machine 200 may include components that may include a processor configured to receive: existing foil parameters, airflow parameters 126, and performance values 128 for the airflow parameters 126 acting on the existing foil parameters, in differing formats; and transform the existing foil parameters, the airflow parameters 126, and the performance values 128 trained in a neural network 214 that pairs them into a unified format in a latent-space representation 216. Machine 200 may further include a neural network 214 configured to iteratively train a design generator to transform and expand the latent-space representation 216 with new foil parameters and performance values 128 associated with the new foil parameters. Machine 200 may further include foundation model 226 configured to receive input 232 that comprises: objectives 228, constraints 230, global foil parameters 106, or desired performance values 128, and transform them into digital inputs to a design algorithm configured to, based upon a trained design generator and the latent-space representation 216, generate parameters that define an optimal foil 211. Without limitation, foundation model by be a foundation model.

Input 232 may be received as a spoken or a natural text. Machine 200 may also include a computer aided design module configured to receive and transform generated parameters into commands to fabricate the optimal foil 211. Machine 200 may also include flight controller computer 242 configured to receive and transform generated parameters into commands to form the optimal foil 211 on an aircraft in flight.

Output 234 from auto-generator 238 processor in Sinamir/machine 200 may also be sent to CAD/CAM processor 240 computer aided design/manufacturing controller used to design and/or control fabrication of optimal foil 211. Thus, as described further below, Sinamir/machine 200 may be a part of manufacturing optimal foil 211. Thus, without limitation, Sinamir/machine 200 may provide the technological improvement that if a mission requirement for an aircraft significantly changes, Sinamir/machine 200 can use constraints 230 and objectives 228 associated with the new mission and a foil therefore, and nearly instantly in real-time design optimal foil 211 for manufacture and retrofit onto the aircraft for the new mission. Hence, as a nonlimiting illustration, an aircraft originally intended for short field operations could be transformed into an aircraft for extended endurance flights.

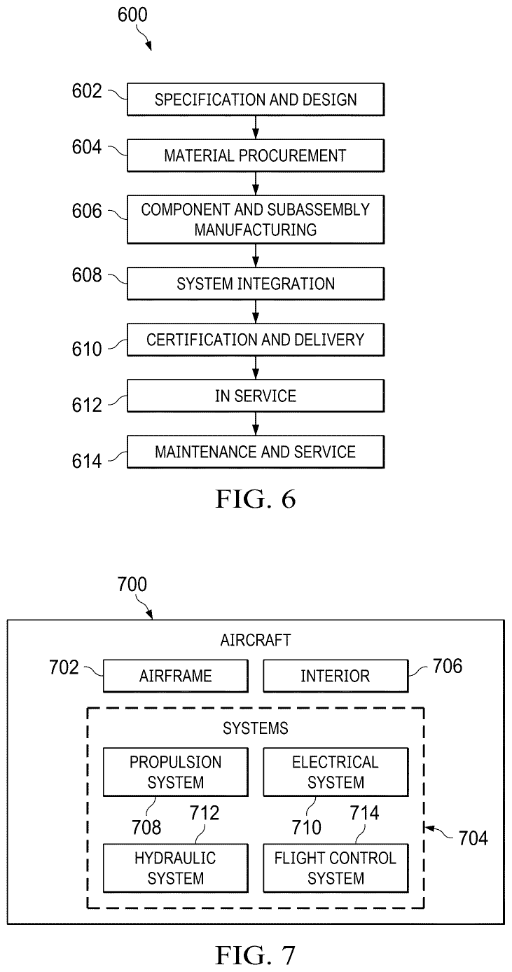

Output 234 from auto generator 238 processor in Sinamir/machine 200 may be paired with or incorporated into a shape changing system 244 for a foil 246 as may be on an aircraft in flight, such as without limitation, aircraft 700 of FIG. 7. Shape changing system 244 may be without limitation, shape changing system described by U.S. Pat. Nos. 8,418,968 and/or 8,056,865 both of which are incorporated herein in their entirety. Without limitation, Sinamir may pair with a shape changing system 244 through a flight control computer 242.

Further, aircraft 700 may feed data in real-time for dimensions 108 of foil 246 and any measured airflow parameters and performance values experienced by aircraft 700 in flight into auto-generator 238 as like input 232 for neural network 214 processing and incorporation into updating, expanding, and/or reformatting, latent-space representation 216.

Hence, Sinamir/machine 200 provides the technological improvement of allowing foil 246 to change shapes in real-time during a flight to provide optimal foil 211 shape for each phase within each flight. For any given phase of flight, flight control computer 242 can provide objectives 228 to auto generator 238 so that neural network 214 can use latent-space representation 216 to predict optimal foil 211 shape 236 for a wing on an aircraft, such as, without limitation, aircraft 700 of FIG. 7. With optimal foil 211 shape 236, flight control computer 242 can derive and direct shape changing system 244 to modify a shape 236 of foil 246 as airflow parameters 126 and objectives 228 and/or constraints 230 change in real-time throughout a flight. Hence, as a nonlimiting illustration, at takeoff Sinamir/machine 200 may generate optimal foil 211 to produce maximum lift 162 possible and during cruise—and throughout cruise as airflow parameters 126 change—change to optimal foil 211 to produce a maximum ratio of lift 162-over-drag 164.

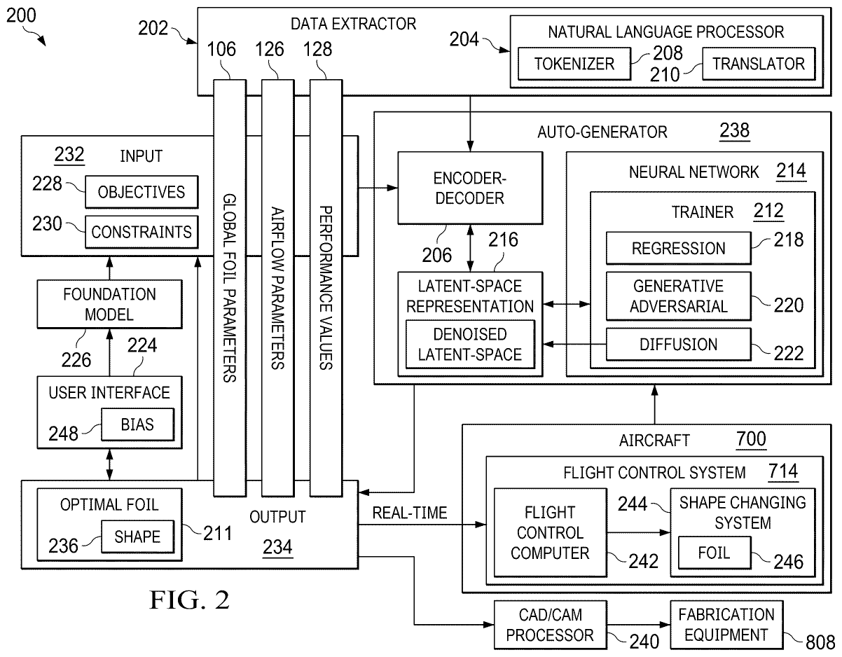

Turning now to FIG. 3, FIG. 3 is a flowchart for a process for creating a foil in accordance with an illustrative embodiment. The process in FIG. 3 can be implemented in hardware, software, or both. When implemented in software, the process can take the form of program instructions that are run by one of more processor units located in one or more hardware devices in one or more computer systems. Specifically, process 300 for creating a foil may include receiving, from a number of databases, digital parameters for existing foils and existing foil designs and performance values therefrom (operation 302); applying, in an auto-encoder, one or more transformations to the digital parameters and generating a latent-space representation of the digital parameters for all of the existing foils and the existing foil designs (operation 304); receiving from the number of databases or deriving, using deep learning and an airflow simulator, performance values for each foil in the existing foils and the existing foil designs in a number of airflow parameters and transforming the latent-space representation by incorporating the performance values and expanding the latent-space representation (operation 306); training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation (operation 308); and further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network (operation 310).

Process 300 may also include the formats among the number of databases being dissimilar. For process 300, deriving the performance values 128 may include: initializing a model of an existing foil or an existing foil design in a digital computer with parameters comprising dimensions 108 and material 118; generating a set of airflow parameters 126 comprising a Mach 138 number and a Reynolds number 142, and simulating the airflow parameters 126 flowing over the model; and applying algorithms simulating the set of airflow parameters 126 over the model and generating the performance values 128 for the model.

Process 300 may also include the digital parameters including at least one of: geometric coordinates for a shape of an existing foil or an existing foil design, and a material 118 of the existing foil or the existing foil design. Process 300 may also include the geometric coordinates being two dimensional coordinates. For process 300, the performance values 128 may include values for: coefficient of pressure 160, lift coefficient 166, drag coefficient 168, and pitching moment coefficient 170. For process 300, the airflow parameters 126 may include at least one of: Reynolds number 142, angle of attack 146, Mach 138 number, density 136, viscosity 140, or compressibility 144.

Further, in process 300, the regression neural network 214 may be replaced and/or supplemented with a generative adversarial 220 network and/or a diffusion 222 model transforming the latent-space representation 216 with a denoised latent-space representation 216. Process 300 may also include receiving, in a neural network 214 comprising a trained latent-space representation 216: objectives 228, constraints 230, or desired foil parameters, and generating parameters of optimal foil 211. The optimal foil 211 may be defined by: geo-coordinates, dimensions 108, and material 118. The optimal foil 211 may include all of objectives 228, constraints 230, and/or the desired foil parameters.

Process 300 may also include receiving, in a design algorithm comprising a trained latent-space representation 216: objectives 228, constraints 230 global foil parameters 106, or desired performance values 128, and producing a list of optimized foils. The objectives 228 may include desired performance values 128. Process 300 may also include training a foundation model 226 wrapper for inputting objectives 228, constraints 230, or foil parameters, into a design algorithm using a trained latent-space representation 216.

Significantly, process 300 may include a design algorithm for generating performance values 128 using the latent-space representation 216 without utilizing: an airflow simulator like XFOIL 150, computational fluid dynamics 152, wind tunnel 154, and/or actual test flights 156. Hence, not only does auto-generator 238 provide the technological advantage of determining in an instant, for objectives 228 and constraints 230, shape 236 for optimal foil 211 but it also provides the technological advantage of providing nearly instantaneous results comparable to those provided currently by performance evaluators 148 while eliminating all the time, resources, man power, and/or associated costs that current performance evaluators 148 require to produce those results. In other words, at a fraction of the time, cost, and resource requirements, auto-generator 238 can replace the product of all current performance evaluators 148.

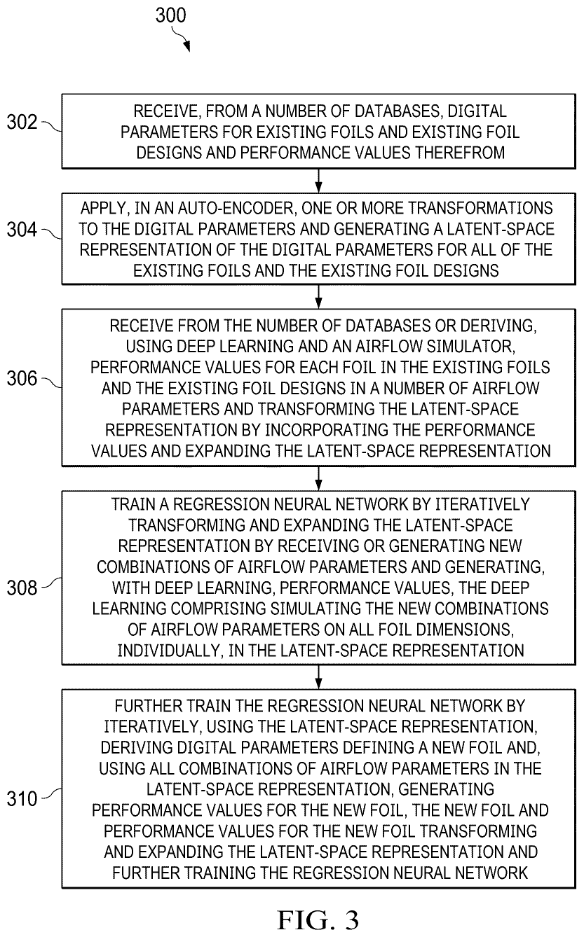

Turning now to FIG. 4, FIG. 4 is a flowchart for a process for manufacturing a foil in accordance with an illustrative embodiment. The process in FIG. 4 can be implemented in hardware, software, or both. When implemented in software, the process can take the form of program instructions that are run by one of more processor units located in one or more hardware devices in one or more computer systems. Specifically, process 400 may include: receiving, from a number of databases, digital parameters for existing foils and existing foil designs and performance values therefrom (operation 402); applying, in an auto-encoder, one or more transformations to the digital parameters and generating a latent-space representation of the digital parameters for all of the existing foils and the existing foil designs (operation 404); receiving from the number of databases or deriving, using deep learning and an airflow simulator, performance values for each foil in the existing foils and the existing foil designs in a number of airflow parameters and transforming the latent-space representation by incorporating the performance values and expanding the latent-space representation (operation 406); training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation (operation 408); further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network (operation 410); receiving in a foundation model an input comprising a spoken or a natural text comprising: objectives, constraints, foil parameters, or desired performance values, and transforming them into digital inputs to a design algorithm configured to, based upon a trained design generator and the latent-space representation, generating parameters defining an optimal foil (operation 412); receiving, in a computer aided design module, generated parameters and transforming them into commands for fabricating the optimal foil (operation 414); and manufacturing, using the commands, the optimal foil (operation 416).

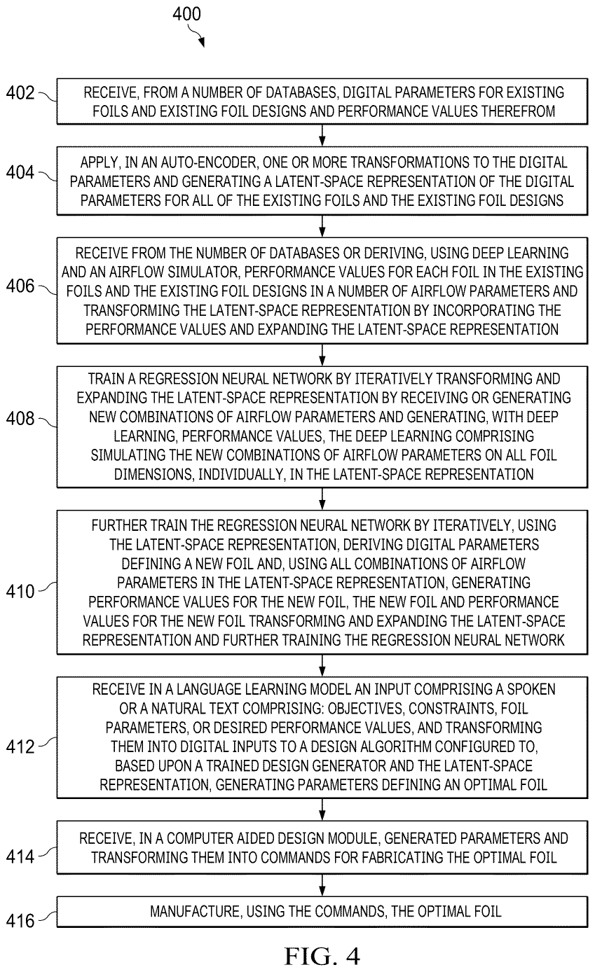

Turning now to FIG. 5, a block diagram of a data processing system is depicted in accordance with an illustrative embodiment. without limitation, data processing system 500 may be considered as a nonlimiting illustration any of the processors shown, described, and/or required in FIGS. 1-4. Without limitation, this may include all of machine 200 shown by FIG. 2 and/or components therein such as auto-generator 238 and/or components thereof, data extractor 202, and/or processors to integrate activities and communications between input 232, foundation model 226, user interface 224, and output 234. In this illustrative block diagram, data processing system 500 includes communications framework 502, which provides communications between processor unit 504, memory 506, persistent storage 508, communications unit 510, input/output (I/O) unit 512, and display 514. In this illustration, communications framework 502 takes the form of a bus system.

Processor unit 504 serves to execute instructions for software that can be loaded into memory 506. Processor unit 504 includes one or more processors. For illustration, processor unit 504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 504 can be implemented using one or more heterogeneous processor systems in which a main processor is present with secondary processors on a single chip. As another illustrative illustration, processor unit 504 can be a symmetric multi-processor system containing multiple processors of the same type on a single chip.

Memory 506 and persistent storage 508 are illustrations of storage devices 516. A storage device is any piece of hardware that is capable of storing information, such as, for illustration,, without limitation, at least one of data, program instructions in functional form, or other suitable information either on a temporary basis, a permanent basis, or both on a temporary basis and a permanent basis. Storage devices 516 may also be referred to as computer-readable storage devices in these illustrative illustrations. Memory 506, in these illustrations, can be, for illustration, a random-access memory or any other suitable volatile or non-volatile storage device. Persistent storage 508 may take various forms, depending on the particular implementation.

For illustration, persistent storage 508 may contain one or more components or devices. For illustration, persistent storage 508 can be a hard drive, a solid-state drive (SSD), a flash memory, a rewritable optical disk, a rewritable magnetic tape, or some combination of the above. The media used by persistent storage 508 also can be removable. For illustration, a removable hard drive can be used for persistent storage 508.

Communications unit 510, in these illustrative illustrations, provides for communications with other data processing systems or devices. In these illustrative illustrations, communications unit 510 is a network interface card.

Input/output unit 512 allows for input and output of data with other devices that can be connected to data processing system 500. For illustration, input/output unit 512 may provide a connection for user input through at least one of a keyboard, a mouse, or some other suitable input device. Further, input/output unit 512 may send output to a printer. Display 514 provides a mechanism to display information to a user.

Instructions for at least one of the operating system, applications, or programs can be located in storage devices 516, which are in communication with processor unit 504 through communications framework 502. The processes of the different embodiments can be performed by processor unit 504 using computer-implemented instructions, which may be located in a memory, such as memory 506.

These instructions are referred to as program instructions, computer usable program instructions, or computer-readable program instructions that can be read and executed by a processor in processor unit 504. The program instructions in the different embodiments can be embodied on different physical or computer-readable storage media 524, such as memory 506 or persistent storage 508.

Program instructions 518 are located in a functional form on computer-readable media 520 that is selectively removable and can be loaded onto or transferred to data processing system 500 for execution by processor unit 504. Program instructions 518 and computer-readable media 520 form computer program product 522 in these illustrative illustrations. In the illustrative illustration, computer-readable media 520 is computer-readable storage media 524.

Computer-readable storage media 524 is a physical or tangible storage device used to store program instructions 518 rather than a medium that propagates or transmits program instructions 518. Computer-readable storage media 524 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer-readable storage media 524, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 518 can be transferred to data processing system 500 using a computer-readable signal media. The computer-readable signal media are signals and can be, for illustration, a propagated data signal containing program instructions 518. For illustration, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 520” can be singular or plural. For illustration, program instructions 518 can be located in computer-readable media 520 in the form of a single storage device or system. In another illustration, program instructions 518 can be located in computer-readable media 520 that is distributed in multiple data processing systems. In other words, some instructions in program instructions 518 can be located in one data processing system while other instructions in program instructions 518 can be located in one data processing system. For illustration, a portion of program instructions 518 can be located in computer-readable media 520 in a server computer while another portion of program instructions 518 can be located in computer-readable media 520 located in a set of client computers.

The different components illustrated for data processing system 500 are not meant to provide architectural limitations to the manner in which different embodiments can be implemented. In some illustrations, one or more of the components may be incorporated in or otherwise form a portion of, another component. For illustration, memory 506, or portions thereof, may be incorporated in processor unit 504 in some illustrations. The different illustrative embodiments can be implemented in a data processing system including components in addition to or in place of those illustrated for data processing system 500. Other components shown in FIG. 5 can be varied from the illustrative illustrations shown. The different embodiments can be implemented using any hardware device or system capable of running program instructions 518.

In the illustrations, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Without limitation, programmable logic devices may include: a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. Without limitation, the processes can be implemented as circuits in organic semiconductors.

As used herein, “a number of” when used with reference to items, means one or more items. Hence, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

Without limitation, “at least one of item A, item B, or item C” may include item A, item A and item B, or item B. This illustration also may include item A, item B, and item C or item B and item C. Of course, any combination of these items can be present. In some illustrations, “at least one of” can be, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. Without limitation, one or more of the blocks can be implemented as program instructions, hardware, or a combination of the program instructions and hardware. When implemented in hardware, the hardware can, for illustration, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. Without limitation, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

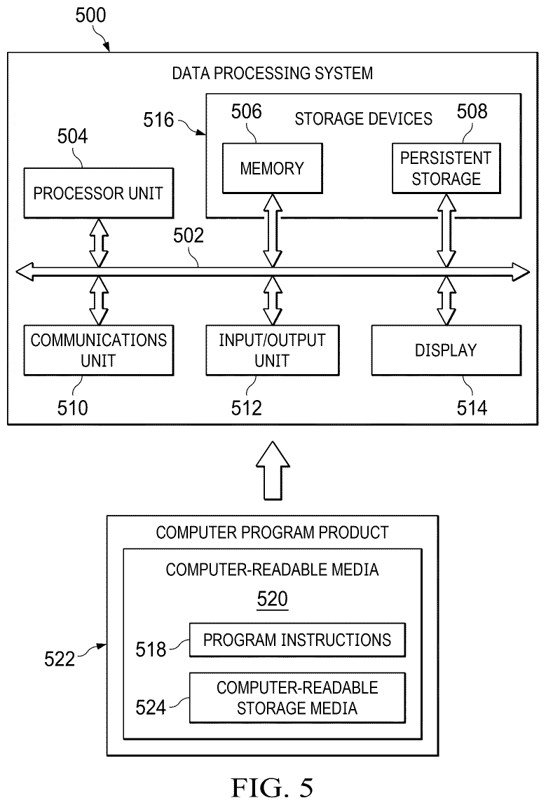

Illustrative embodiments of the disclosure may be described in the context of aircraft manufacturing and service method 600 as shown in FIG. 6 and aircraft 700 as shown in FIG. 7. Turning first to FIG. 6, an illustration of an aircraft manufacturing and service method is depicted in accordance with an illustrative embodiment. During pre-production, aircraft manufacturing and service method 600 may include specification and design 602 of aircraft 700 in FIG. 7 and material procurement 604.

During production, component and subassembly manufacturing 606 and system integration 608 of aircraft 700 in FIG. 7 takes place. Thereafter, aircraft 700 in FIG. 7 can go through certification and delivery 610 in order to be placed in service 612. While in service 612 by a customer, aircraft 700 in FIG. 7 is scheduled for routine maintenance and service 614, which may include modification, reconfiguration, refurbishment, and other maintenance or service.

Each of the processes of aircraft manufacturing and service method 600 may be performed or carried out by a system integrator, a third party, an operator, or some combination thereof. In these illustrations, the operator may be a customer. For the purposes of this description, a system integrator may include,, without limitation, any number of aircraft manufacturers and major-system subcontractors; a third party may include,, without limitation, any number of vendors, subcontractors, and suppliers; and an operator may be an airline, a leasing company, a military entity, a service organization, and so on.

With reference now to FIG. 7, an illustration of an aircraft is depicted in which an illustrative embodiment may be implemented. In this illustration, aircraft 700 is produced by aircraft manufacturing and service method 600 in FIG. 6 and may include airframe 702 with plurality of systems 704 and interior 706. Without limitation, systems 704 include one or more of propulsion system 708, electrical system 710, hydraulic system 712, and flight control system 714. Optimal foil 211 may be considered as a part of airframe 702 and/or a part of flight control system 714. Flight control system 714 may also include flight control computer 242 and/or shape changing system 244 from FIG. 2. Any number of other systems may be included. Although an aerospace illustration is shown, different illustrative embodiments may be applied to other industries, such as without limitation marine or automotive industry applications.

Apparatuses and methods embodied herein may be employed during at least one of the stages of aircraft manufacturing and service method 600 in FIG. 6.

Without limitation, components or subassemblies produced in component and subassembly manufacturing 606 in FIG. 6 can be fabricated or manufactured in a manner similar to components or subassemblies produced while aircraft 700 is in service 612 in FIG. 6. As yet another illustration, one or more apparatus embodiments, method embodiments, or a combination thereof can be utilized during production stages, such as component and subassembly manufacturing 606 and system integration 608 in FIG. 6. One or more apparatus embodiments, method embodiments, or a combination thereof may be utilized while aircraft 700 is in service 612, during maintenance and service 614 in FIG. 6, or both. Retrofit of optimal foil 211 onto an existing aircraft 700 may be considered as a portion of maintenance and service 614. The use of a number of the different illustrative embodiments may substantially expedite the assembly of aircraft 700, reduce the cost of aircraft 700, or both expedite the assembly of aircraft 700 and reduce the cost of aircraft 700.

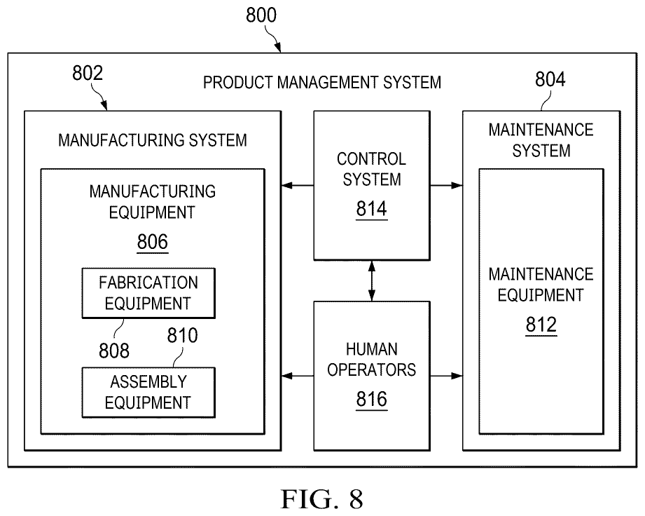

Turning now to FIG. 8, an illustration of a block diagram of a product management system is depicted in accordance with an illustrative embodiment. Product management system 800 is a physical hardware system. In this illustration, product management system 800 includes at least one of manufacturing system 802 or maintenance system 804.

Manufacturing system 802 is configured to manufacture products, such as aircraft 700 in FIG. 7. As depicted, manufacturing system 802 includes manufacturing equipment 806. Manufacturing equipment 806 includes at least one of fabrication equipment 808 or assembly equipment 810 for manufacture of optimal foil 211.

Fabrication equipment 808 is equipment that is used to fabricate components or parts, such as, without limitation, optimal foil 211 used to form aircraft 700 in FIG. 7. Without limitation, fabrication equipment 808 can include machines and tools. These machines and tools can be at least one of: a drill, a hydraulic press, a furnace, an autoclave, a mold, a composite tape laying machine, an automated fiber placement (AFP) machine, a vacuum system, a robotic pick and place system, a flatbed cutting machine, a laser cutter, a computer numerical control (CNC) cutting machine, a lathe, or other suitable types of equipment. Fabrication equipment 808 can be used to fabricate at least one of metal parts, composite parts, semiconductors, circuits, fasteners, ribs, skin panels, spars, antennas, or other suitable types of parts.

Assembly equipment 810 is equipment used to assemble parts to form aircraft 700 in FIG. 7. In particular, assembly equipment 810 is used to assemble components and parts to form aircraft 700 in FIG. 7. Assembly equipment 810 also can include machines and tools. These machines and tools may be at least one of a robotic arm, a crawler, a fastener installation system, a rail-based drilling system, or a robot. Assembly equipment 810 can be used to assemble parts such as seats, horizontal stabilizers, wings, engines, engine housings, landing gear systems, and other parts for aircraft 700 in FIG. 7.

Without limitation, maintenance system 804 may include maintenance equipment 812. Maintenance equipment 812 can include any equipment needed to perform maintenance on aircraft 700 in FIG. 7. Maintenance equipment 812 may include tools for performing different operations on parts on aircraft 700 in FIG. 7. These operations can include at least one of disassembling parts, refurbishing parts, inspecting parts, reworking parts, manufacturing replacement parts, or other operations for performing maintenance on aircraft 700 in FIG. 7. These operations can be for routine maintenance, inspections, upgrades, refurbishment, or other types of maintenance operations.

Without limitation, maintenance equipment 812 may include ultrasonic inspection devices, x-ray imaging systems, vision systems, drills, crawlers, and other suitable devices. In some cases, maintenance equipment 812 can include fabrication equipment 808, assembly equipment 810, or both to produce and assemble parts that are needed for maintenance.

Product management system 800 also includes control system 814. Control system 814 is a hardware system and may also include software or other types of components. Control system 814 is configured to control the operation of at least one of manufacturing system 802 or maintenance system 804. In particular, control system 814 can control the operation of at least one of fabrication equipment 808, assembly equipment 810, or maintenance equipment 812.

The hardware in control system 814 can be implemented using hardware that may include computers, circuits, networks, and other types of equipment. The control may take the form of direct control of manufacturing equipment 806. Without limitation, robots, computer-controlled machines, and other equipment can be controlled by control system 814. In other illustrative illustrations, control system 814 can manage operations performed by human operators 816 in manufacturing or performing maintenance on aircraft 700. Without limitation, control system 814 can assign tasks, provide instructions, display models, or perform other operations to manage operations performed by human operators 816. Without limitation, CAD/CAM processor 240 from FIG. 2 can be implemented in control system 814 to manage at least one of the manufacturing or maintenance of aircraft 700 in FIG. 7.

Without limitation, human operators 816 can operate or interact with at least one of manufacturing equipment 806, maintenance equipment 812, or control system 814. This interaction can occur to manufacture aircraft 700 in FIG. 7.

Of course, product management system 800 may be configured to manage other products other than aircraft 700 in FIG. 7. Although product management system 800 has been described with respect to manufacturing in the aerospace industry, product management system 800 can be configured to manage products for other industries. Without limitation, product management system 800 can be configured to manufacture products for the automotive industry as well as any other suitable industries.

The description of the different illustrative embodiments has been presented for purposes of illustration and description and is not intended to be exhaustive or limited to the embodiments in the form disclosed. The different illustrations describe components that perform actions or operations. In an illustrative embodiment, a component can be configured to perform the action or operation described. Without limitation, the component can have a configuration or design for a structure that provides the component an ability to perform the action or operation that is described in the illustrative illustrations as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A process for creating a foil, the process comprising:
receiving, from a number of databases, digital parameters for existing foils and existing foil designs and performance values therefrom;
applying, in an auto-encoder, one or more transformations to the digital parameters and generating a latent-space representation of the digital parameters for all of the existing foils and the existing foil designs;
receiving from the number of databases or deriving, using deep learning and an airflow simulator, performance values for each foil in the existing foils and the existing foil designs in a number of airflow parameters and transforming the latent-space representation by incorporating the performance values and expanding the latent-space representation;
training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation; and
further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network.

2. The process of claim 1, wherein formats among the number of databases are dissimilar.

3. The process of claim 1, wherein deriving the performance values comprises a:
initializing a model of an existing foil or an existing foil design in a digital computer with parameters comprising dimensions and materials;
generating a set of airflow parameters comprising a Mach number and a Reynolds number, and simulating the airflow parameters flowing over the model; and
applying algorithms simulating the set of airflow parameters over the model and generating the performance values for the model.

4. The process of claim 1, wherein the digital parameters comprise at least one of: geometric coordinates for a shape of an existing foil or an existing foil design, and a material of the existing foil or the existing foil design.

5. The process of claim 4, wherein the geometric coordinates are two dimensional coordinates.

6. The process of claim 1, wherein the performance values include values for:
coefficient of pressure, lift coefficient, drag coefficient, and pitching moment coefficient.

7. The process of claim 1, wherein the airflow parameters comprise at least one of: Reynolds number, angle of attack, Mach number, density, viscosity, or compressibility.

8. The process of claim 1, further comprising replacing the regression neural network with a generative adversarial network.

9. The process of claim 1, further comprising replacing the regression neural network with a latent diffusion model transforming the latent-space representation with a denoised latent-space representation.

10. The process of claim 1, further comprising receiving, in a neural network comprising a trained latent-space representation: objectives, constraints, or desired foil parameters, and generating parameters of an optimal foil.

11. The process of claim 10, wherein the optimal foil comprises: geo-coordinates, dimensions, and materials defining the optimal foil.

12. The process of claim 10, wherein the optimal foil comprises all of the desired foil parameters.

13. The process of claim 1, further comprising receiving, in design algorithm comprising a trained latent-space representation: objectives, constraints foil parameters, or desired performance values, and producing a list of optimized foils.

14. The process of claim 13, wherein the objectives are desired performance values.

15. The process of claim 1, further comprising training a foundation model wrapper for inputting objectives, constraints, or foil parameters, into a design algorithm using a trained latent representation.

16. The process of claim 1, further comprising a design algorithm for generating performance values using the latent-space representation without utilizing: an airflow simulator, computational fluid dynamics, or a wind tunnel.

17. A machine configured to manufacture a foil, wherein the machine comprises:
a processor configured to:
receive inputs comprising: existing foil parameters, airflow parameters, and performance values for the airflow parameters acting on the existing foil parameters, in differing formats; and
transform the inputs of: the existing foil parameters, the airflow parameters, and the performance values, trained in a neural network that pairs them into a unified format in a latent-space representation;
a neural network configured to iteratively train a design generator to transform and expand the latent-space representation with new foil parameters and performance values associated with the new foil parameters; and
a foundation model configured to receive an input that comprises: objectives, constraints, foil parameters, or desired performance values, and transform them into digital inputs to a design algorithm configured to, based upon a trained design generator and the latent-space representation, generate parameters that define an optimal foil.

18. The machine of claim 17, wherein the input comprises a spoken or a natural text.

19. The machine of claim 17, further comprising a computer aided design module configured to receive and transform generated parameters into commands to fabricate the optimal foil.

20. A process for manufacturing a foil, the process comprising:
receiving, from a number of databases, digital parameters for existing foils and existing foil designs and performance values therefrom;
applying, in an auto-encoder, one or more transformations to the digital parameters and generating a latent-space representation of the digital parameters for all of the existing foils and the existing foil designs;
receiving from the number of databases or deriving, using deep learning and an airflow simulator, performance values for each foil in the existing foils and the existing foil designs in a number of airflow parameters and transforming the latent-space representation by incorporating the performance values and expanding the latent-space representation;
training a regression neural network by iteratively transforming and expanding the latent-space representation by receiving or generating new combinations of airflow parameters and generating, with deep learning, performance values, the deep learning comprising simulating the new combinations of airflow parameters on all foil dimensions, individually, in the latent-space representation;
further training the regression neural network by iteratively, using the latent-space representation, deriving digital parameters defining a new foil and, using all combinations of airflow parameters in the latent-space representation, generating performance values for the new foil, the new foil and performance values for the new foil transforming and expanding the latent-space representation and further training the regression neural network;
receiving in a foundation model an input comprising a spoken or a natural text comprising: objectives, constraints, foil parameters, or desired performance values, and transforming them into digital inputs to a design algorithm configured to, based upon a trained design generator and the latent-space representation, generating parameters defining an optimal foil;
a computer aided design module receiving generated parameters and transforming them into commands for fabricating the optimal foil; and
manufacturing, using the commands, the optimal foil.
